(19) United States
(12) Patent Application Publication
(10) Pub. No.: US 2015/0163844 A1
(43) Pub. Date: Jun. 11, 2015

(54) COMMUNICATION SYSTEM IN AN AIRCRAFT COMPRISING A REDUNDANT NETWORK

(71) Applicant: Airbus Operations (SAS), Toulouse (FR)

(72) Inventors: Pau LATORRE-COSTA, Toulouse (FR); David REULET, Garac (FR)

(21) Appl. No.: 14/556,834

(22) Filed: Dec. 1, 2014

(30) Foreign Application Priority Data
Dec. 6, 2013 (FR) 1362224

(51) Int. Cl. H04W 76/02; H04L 29/08; H04L 29/06; H04L 12/24

(52) U.S. Cl. CPC H04W 76/027; H04L 41/069; H04L 67/12; H04L 69/14; H04W 84/22

(57) ABSTRACT

A reinforcement of the security of communications in an aircraft by providing a communication system including a wired network interconnecting various items of equipment of the aircraft and intended to act as medium for the communications between the items of equipment, and a wireless network configured to act as communication medium between eligible items of equipment suitable for wireless communications and no longer able to communicate by the wired network.

### CROSS-REFERENCES TO RELATED APPLICATIONS

This application claims the benefit of the French patent application No. 1362224 filed on Dec. 6, 2013, the entire disclosures of which are incorporated herein by way of reference.

### BACKGROUND OF THE INVENTION

The present invention relates, generally, to communication systems in an aircraft.

Currently, items of equipment in an aircraft can exchange signals of analogue or digital type with each other according to various communication means and protocols.

Communication between items of equipment can be of point-to-point type with direct physical links between items of equipment. For example, a computer can be connected via individual links with a plurality of other computers and/or controllers.

However, with the increase in the complexity of aeronautical systems, wired networks such as ARINC 429 networks or AFDX (a trademark of Airbus) networks are used, these networks being intended to act as media for the communications between the various items of equipment of the aircraft.

It will be recalled that the AFDX network relies on the concept of a virtual link defined as an oriented path across the network, originating from a source terminal and serving a destination or a plurality of destinations. A destination terminal of a virtual link is said to be subscribed to this link.

Furthermore, the AFDX network is full-duplex and deterministic. The term full-duplex is understood to mean that each terminal can simultaneously send and receive frames on virtual links over the same physical link. The AFDX network is deterministic, in the sense that virtual links have guaranteed characteristics in terms of latency limit, physical segregation of flows, bandwidth and speed. Therefore, each virtual link employs a path reserved from end to end across the network. The data are transmitted in the form of IP packets wrapped in Ethernet frames. The switching of frames on an AFDX network uses a virtual link ID included in the frame header. When a switch receives a frame on one of its input ports, it reads the virtual link ID and determines from its switching table the output port(s) on which it must be transmitted.

Furthermore, for stringent safety requirements, many direct links of point-to-point type are maintained with emergency equipment in parallel with and independent of the main wired network.

The subject of the present invention is to provide a communication system making it possible to further reinforce the security of communications between items of equipment required for flight safety.

### SUMMARY OF THE INVENTION

The present invention is defined by a communication system of an aircraft including a wired network interconnecting various items of equipment of the aircraft and intended to act as medium for the communications between said items of equipment, said system furthermore including a wireless network configured to act as communication medium between eligible items of equipment suitable for wireless communications and no longer able to communicate by the wired network.

Thus, the wireless redundancy network takes over the exchange of information between two items of equipment equipped with wireless transmission circuits in the event of their physical network being interrupted.

Advantageously, said wireless network has on its upper layers a protocol identical to that of the wired network. Note moreover that the communication over the wireless network can be limited to basic commands.

This makes it possible to maximize the compatibility between the two networks while avoiding data conversion. The wired network is for example an AFDX network and the wireless network is a WiFi network.

According to an embodiment of the invention, the communication system includes monitoring units configured to supervise the availability of the wired network and to make a communication switch between two eligible items of equipment on the medium of the wireless network when no physical link between said two items of equipment is operative.

This makes it possible to detect any unavailability of a physical link simply and accurately.

Said monitoring units can be configured to supervise the physical layer of the wired network or to supervise the confirmation of the exchange of data.

Thus, in a first variant, the supervision of the wired network can be performed directly on the physical layer by detecting, for example, any disconnection or short circuit of the physical links. In a second variant, the supervision of the wired connection between two items of equipment can be performed by an algorithm confirming data transmission between the two items of equipment.

Advantageously, the wireless network is configured to remain in stand-by mode as long as the wired network is operational.

Thus, the wireless network does not intervene as long as the physical links are available.

Advantageously, the wireless network is configured to perform at predetermined times a self-test of the communication capacity between various eligible items of equipment and to report any unresponsive item of equipment.

This makes it possible to detect any anomaly in the wireless network.

Advantageously, each eligible item of equipment includes a wireless transceiver circuit and a monitoring unit, two wireless transceiver circuits respectively belonging to two eligible items of equipment being activated by the corresponding monitoring units when all the physical links between said two items of equipment are unavailable.

This allows a simple resumption of communications between the two items of equipment.

Advantageously, the communication system includes cryptographic means for encoding and signing the messages broadcast across the wireless network.

This makes it possible to exchange data between the items of equipment in perfect security.

Advantageously, the eligible items of equipment are configurable as access points in such a way that when all the means for communicating between first and second eligible items of equipment are unavailable, a third eligible item of equipment configures itself as an access point to route the transmission of data between said first and second items of equipment.

This allows wireless communication between two items of equipment not having or no longer having the physical capacity to communicate across the wireless network.

Finally, the invention relates to an aircraft, comprising a communication system as defined above.

### BRIEF DESCRIPTION OF THE DRAWINGS

Other features and advantages of the invention will become apparent upon reading the preferred embodiments of the invention, made with reference to the attached figures, among which:

FIG. 1 is a schematic illustration of a communication system of an aircraft according to an embodiment of the invention;

FIG. 2 is a schematic representation of a communication system of an aircraft including monitoring units according to an embodiment of the invention; and

FIG. 3 is a schematic representation of a communication system of an aircraft according to another embodiment of the invention.

### DETAILED DESCRIPTION OF THE PREFERRED EMBODIMENTS

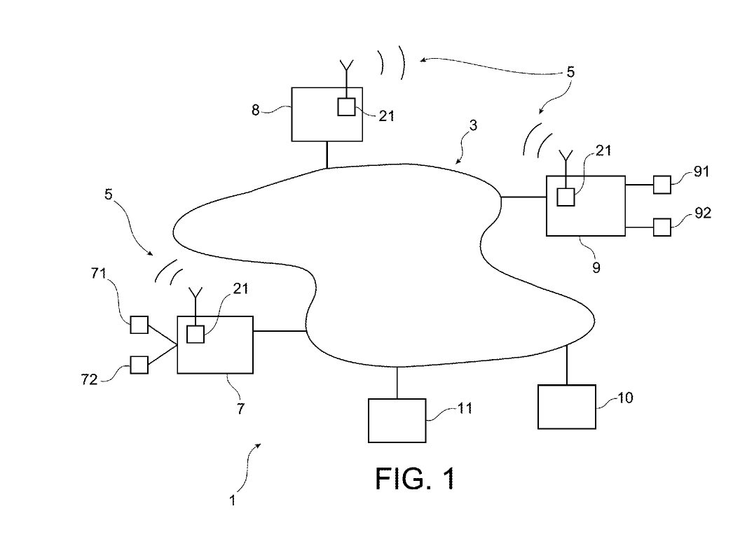

FIG. 1 is a schematic representation of a communication system of an aircraft according to an embodiment of the invention. The communication system is generally associated with elementary command systems taking charge of particular functions of the aircraft.

In accordance with the invention, the communication system 1 comprises a wired network 3 such as an ARINC network or an AFDX network and a wireless redundancy network 5.

The wired network 3 is intended to connect to a plurality of items of equipment 7-11 of the aircraft and thus to serve as physical medium for the communications between these various items of equipment.

The equipment of the aircraft for example comprises human-machine interfaces 7 linked to display 71 and piloting 72 means, computers 8, data hubs 9 providing the interfaces between the wired network and analogue links with sensors 91 and/or actuators 92, controllers 10, and configuration or supervision terminals 11. For example a sensor 91 can supply measurements in analogue form to the corresponding data hub 9 and the latter formats them into AFDX messages to send them to the dedicated computer 8. In the same way, the computer 8 can transmit a setpoint to a control unit (not represented) of an actuator 92. Of course, the sensors 91 and/or actuators 92 can also be linked in an analogue manner directly to their computer and/or dedicated controller.

The wireless network 5 is intended to interconnect at least some 7, 8, 9 of the plurality of items of equipment. More particularly, certain items of equipment of the aircraft, referred to hereinbelow as eligible items of equipment 7-9, are configured to be able to communicate with each other via the wireless network 5. Indeed, a wireless transceiver circuit 21 can be incorporated into each eligible item of equipment 7-9. In accordance with the invention, the wireless network 5 is configured to act as communication medium between the eligible items of equipment 7-9 that are no longer able to communicate with each other by the wired network 5. In other words, two eligible items of equipment communicate with each other via the wireless network solely in the case where the latter can no longer communicate via physical links because of unavailability of these links, due for example to a disconnection of all the links between the two items of equipment. Thus, when an incident interrupts the physical links between two eligible items of equipment, the wireless network 5 is activated to re-establish the link between these two items of equipment.

It will be noted that the eligible items of equipment 7-9 are selected by assessment according to the importance or criticality of the item of equipment for the security of the aircraft, and, optionally, all the items of equipment of the aircraft can be selected to be able to communicate with each other via the wireless network 5. Moreover, the data broadcast across the wireless network 5 can be impaired compared to those broadcast in the nominal wired mode. Communication in the wireless network 5 is for example limited to basic safety or emergency messages or commands.

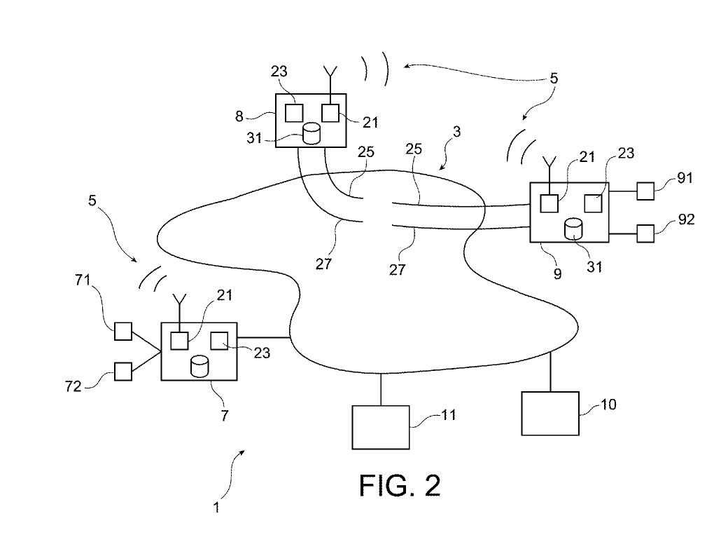

According to an embodiment of the invention, the communication system 1 includes monitoring units (see FIG. 2) configured to supervise the availability of the wired network 5 and to make a communication switch between two eligible items of equipment 7-9 on the medium of the wireless network 5 when no physical link between the two items of equipment is operative.

Indeed, FIG. 2 is a schematic representation of a communication system of an aircraft including monitoring units according to an embodiment of the invention. FIG. 2 also represents the method of communication between two items of equipment via the wireless network according to an embodiment of the invention.

According to the example in FIG. 2, each eligible item of equipment 7-9 includes a monitoring unit 23 in addition to the wireless transceiver circuit 21. Thus, when all the physical links 25, 27 between two eligible items of equipment 8, 9 are unavailable, the transceiver circuit 21 of each of the two items of equipment is activated by the corresponding monitoring unit 23 allowing the resumption of communications between the two items of equipment 8, 9.

The monitoring units 23 are for example configured to supervise the confirmation of the exchange of data between the various items of equipment. In this case, each monitoring unit 23 can correspond to an algorithm implemented for detecting the reception (or the non-reception) of data by the destination equipment. For example, beyond a predetermined maximum waiting time (for example one second), if an eligible item of equipment 8 sending a message via the wired network 3 does not receive any acknowledgment of receipt from the destination 9 then the monitoring unit 23 of the sending equipment 21 considers that all the physical links 25, 27 with the destination 9 are unavailable and consequently activates the transceiver circuit 21 to resume the communication with the destination 9 via the wireless network 5 in the case where the latter is eligible.

In a variant, the monitoring units 23 are configured to directly supervise the physical layer of the wired network 3. Each monitoring unit 23 for example includes a detector suitable for detecting any disconnection or short circuit in the neighboring physical links. Thus, when the monitoring units 23 of two eligible items of equipment 8, 9 detect disconnections in the physical links 25, 27 preventing any communication via the wired network 3 between the two items of equipment, then the corresponding wireless transceiver circuits 21 are activated to resume the communication via the wireless network 5.

It will be noted that the wireless network 5 can be implemented according to a standard WiFi protocol, for example. For example, the internal layers of the wireless network 5 can be implemented according to the IEEE 802.11 standards operating within the limits of a 2.4 GHz frequency band. Advantageously, the wireless network 5 has on these upper layers a protocol identical to that of the wired network 3. Thus, the two networks 3 and 5 have the same protocol at frame level, making it possible to maximize compatibility and to simplify exchanges of data between the various eligible items of equipment 7-9 without protocol conversion. Each eligible item of equipment can simultaneously send and receive data in the form of IP packets wrapped in frames identical to those of the wired network 3. The switching of frames on the wireless network 5 can also use an ID or address included in the frame header.

Note that the wireless network 5 is not involved when the physical links are available. Thus, the wireless network 5 is configured to remain in stand-by mode as long as the wired network 3 is operational. In other words, as long as a physical path exists between two items of equipment, the wireless network 5 remains in stand-by between these two items of equipment. However, the wireless network 5 can optionally be configured to perform at predetermined times (for example regular times in the course of the flight) a self-test of the communication capacity between the various eligible items of equipment 7-9. Indeed, the monitoring units 23 can activate the wireless transceiver circuits 21 at the predetermined times to test the wireless connections between the various eligible items of equipment 7-9 and to report any unresponsive item of equipment.

Advantageously, the communication system 1 includes cryptographic means for encoding and signing the messages broadcast across the wireless network. A cryptographic protocol with a public key and a private key can be used for the exchange of data between the eligible items of equipment. Each eligible item of equipment 7-9 includes a storage means 31 in which a private key is stored as well as a list of all the public keys of the other eligible items of equipment. Moreover, the set of private and public keys differs from one aircraft to another.

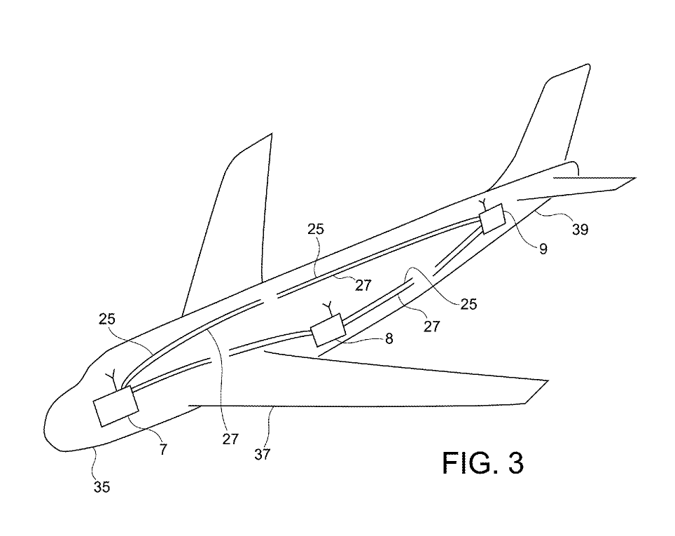

FIG. 3 is a schematic representation of a communication system of an aircraft according to yet another embodiment of the invention.

For the sake of clarity, FIG. 3 illustrates a communication system 1 including only three eligible items of equipment 7-9. According to this example, all the wired means 25, 27 between the first 7, second 8 and third 9 items of equipment are unavailable. Moreover, the wireless communication capacity between the first item of equipment 7 and the third item of equipment 9 is unavailable because of some kind of a physical incapacity, which can be due to an incident or to a long distance between the two items of equipment. The first 7 and third 9 items of equipment can for example be very far apart from each other with respect to the capacity of the wireless network 5. The first item of equipment 7 is for example installed in the cockpit 35 of a long-haul aircraft 37 while the third item of equipment 9 is installed in the rudder unit 39 of this aircraft 37. The long distance between the first 7 and third 9 items of equipment can prevent any direct wireless link with an acceptable performance. Then the second item of equipment 8, which is for example found in the middle of the aircraft 37 can act as a connection gateway in order to retrieve the data of the first item of equipment 7 to send them to the second item of equipment 9 and vice versa.

Indeed, according to this embodiment, the wireless applications of eligible items of equipment 7-9 are configurable as access points. Thus, when all the means for communicating (wired and wireless) between two eligible items of equipment 7, 9 are unavailable, an intermediate eligible item of equipment 8 configures itself as an access point to route the transmission of data between these two items of equipment 7, 9.

The embodiment in FIG. 3 thus presents an additional layer of redundancy based on the routing of the data across the wireless network 5 via the available access points 8, thus reinforcing the level of security of the communication system 1. In addition, this enables monitoring or extensive supervision of communications from end to end of the communication system.

Note moreover that the wireless network is very robust, suitable for being used in the avionics field, and has a format compatible with a wired network, such as an AFDX network while being sufficiently dissimilar to also respond to a generic failure due to the wired network.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A communication system of an aircraft comprising:
a wired network interconnecting various items of equipment of the aircraft and configured to act as medium for the communications between said items of equipment, and
a wireless network configured to act as communication medium between eligible items of equipment suitable for wireless communications and no longer able to communicate by the wired network,
said wireless network having on its upper layers a protocol identical to that of the wired network.

2. The system according to claim 1, further comprising monitoring units configured to supervise the availability of the wired network and to make a communication switch between two eligible items of equipment on the medium of the wireless network when no physical link between said two items of equipment is operative.

3. The system according to claim 2, wherein said monitoring units are configured to supervise one of the physical layer of the wired network and the confirmation of the exchange of data.

4. The system according to claim 1, wherein the wireless network is configured to remain in stand-by mode as long as the wired network is operational.

5. The system according to claim 1, wherein the wireless network is configured to perform at predetermined times a self-test of the communication capacity between various eligible items of equipment and to report any unresponsive item of equipment.

6. The system according to claim 1, wherein each eligible item of equipment includes a wireless transceiver circuit and a monitoring unit, two wireless transceiver circuits respectively belonging to two eligible items of equipment being activated by the corresponding monitoring units when all the physical links between said two items of equipment are unavailable.

7. The system according to claim 1, further comprising a cryptographic protocol for encoding and signing the messages broadcast across the wireless network.

8. The system according to claim 1, wherein the eligible items of equipment are configurable as access points in such a way that when the wired and wireless networks for communicating between first and second eligible items of equipment are unavailable, a third eligible item of equipment configures itself as an access point to route the transmission of data between said first and second items of equipment.

9. An aircraft including a communication system comprising:
a wired network interconnecting various items of equipment of the aircraft and configured to act as medium for the communications between said items of equipment, and
a wireless network configured to act as communication medium between eligible items of equipment suitable for wireless communications and no longer able to communicate by the wired network,
said wireless network having on its upper layers a protocol identical to that of the wired network.
